(19) United States
(12) Patent Application Publication
(10) Pub. No.: US 2003/0193311 A1
(43) Pub. Date: Oct. 16, 2003

(54) System and method for charging a battery

(75) Inventors: Gerhard Konrad, Ulm (DE); Michael Niehues, Ulm (DE); Bernd Spier, Burgrieden (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/405,741

(22) Filed: Apr. 2, 2003

(30) Foreign Application Priority Data
Apr. 13, 2002 (DE) 102 16 353.7

(51) Int. Cl. H02J 7/00

(52) U.S. Cl. 320/103

(57) ABSTRACT

A system and a method are used for charging a battery which is connected to intermittently operated devices for providing power required for charging, such as an engine-driven generator in a motor vehicle, for example. In order to provide the battery with additional charge, a fuel cell system is also used. The battery may be kept at a minimum specified state of charge, for example, by the fuel cell system. Discharge by stand-by currents or leakage currents may be compensated or maintenance charge may be provided to the approximately fully charged battery to extend its service life.

Priority to German Patent Application No. 102 16 353.7, filed Apr. 13, 2002 and hereby incorporated by reference herein, is claimed.

### BACKGROUND INFORMATION

The present invention relates to a system and a method for charging a battery which is connected to intermittently operated devices for providing power required for charging.

Batteries, in particular batteries having a capacity of more than 10 Ah (amp-hours), are known from the general related art; such batteries are connected to intermittently operated devices for providing power required for charging. They include starter batteries, traction batteries, and/or on-board system batteries for vehicles such as motor vehicles, motorcycles, yachts, or batteries of power supplies that are independent of the on-board system, such as systems having a battery and photovoltaic modules. Intermittently operating devices for providing power required for charging include drive motors and associated generators, photovoltaic modules, or the like.

All batteries of this type are charged intermittently by the surplus power from the devices. The battery then remains charged between the individual charging operations or is discharged again by the currents required. On average, a battery of this type is always below the maximum possible state of charge, so that corrosion causes a reduction in the maximum possible service life. Furthermore, a battery may be discharged by self-discharge, or via leakage currents or standby currents by consumers, even with the system shut off, which then makes it impossible to restart the system using the battery. This is particularly disadvantageous in the case of starter batteries of motor vehicles or in safety-relevant systems such as emergency call or alarm systems which are independent of an on-board system, for example.

### BRIEF SUMMARY OF THE INVENTION

An object of the present invention is therefore to provide a device for charging a battery which is connected to intermittently operated devices for providing power required for charging, which would ensure the availability of the battery at all times, regardless of a stationary power supply, equalizes the charge balance of the battery, and extends the service life of the battery.

The present invention provides a system for charging a battery which is connected to intermittently operated devices for providing power required for charging, wherein additional devices, which are designed as a fuel cell system (4), are present for providing power for an additional charge to the battery (2).

The fuel cell system allows the battery to be provided with additional charge in a controlled manner using the simplest means and consuming little power, and may advantageously have a very compact design. It is independent of the devices for providing power for charging the battery.

By providing additional charge using the fuel cell system, deep discharge of the battery, which would considerably impair its service life, is particularly advantageously avoidable. Furthermore, the fuel cell system makes maintenance charging of the battery possible, the battery charged by the intermittently operated devices for providing power required for charging being provided with additional charge by the fuel cell system via small currents in order to keep the battery active and utilizable over its entire capacity range. By thus activating the battery beyond the charge achieved via the intermittently operated devices for providing the power required for charging, the service life of the battery is also affected in a very positive manner. This time-consuming measure, known per se, which was to be previously only performed via external maintenance charging of the battery by a trained user, in general using power-line-dependent charging devices may thus very easily and simply be integrated into a mass-produced system, for example. The advantages include extension of battery life and the associated reduction in material, costs, and complexity.

Furthermore, it is always possible to ensure a minimum state of charge of the battery, keeping the system equipped with the battery always ready for operation. This is particularly advantageous, for example, in the case of starter batteries of vehicles or in safety-relevant systems such as emergency call or alarm systems supplied independently of a power system.

Furthermore, the fuel cell system, when used, for example, for providing the battery with additional charge in a vehicle operated in the start-stop mode, makes it possible to equalize the charge balance and reduce the load on the battery when braking power recovery is used. The additional charge may help compensate for charge deficits caused by failure to obtain sufficient power from the braking power recovery for restart or by this power being generated in an excessively short time for being fully stored without thermally overloading the battery due to its relatively high internal resistance in general. The fuel cell system as a mass-produced component of such a start-stop system allows the required charge equalization, complying with the requirements of the NEFZ (New European Driving Cycle).

The fuel cell system itself may be designed for the system according to the present invention as a basic system. Thus, according to a very advantageous embodiment of the present invention, the fuel cell system includes a fuel tank and at least one fuel cell which is self-breathing at least in the low and medium power output ranges, the fuel tank being designed such that the fuel reaches the area of an anode of the fuel cell without the help of a delivery device.

This basic fuel cell system, in which air reaches the area of the cathode, at least for the low- to medium-power range, which is used over most of the operating time, by free convection, i.e., without requiring auxiliary power, is perfectly sufficient for achieving the above-named advantages. Additional components and auxiliary power are not required due to the design of the fuel tank so that the fuel reaches the area of the fuel cell anode without the help of a delivery device, for example, by gravity or a pressure prevailing in the fuel tank. The space required by the fuel cell system and its complexity may thus be reduced to a minimum.

The present invention also provides a method of providing a battery, connected to an intermittently operated device for providing power required for charging the battery, with additional charge, wherein a fuel cell system (4) for providing the battery (2) with additional charge is used when devices (3) for providing the power required for charging the battery (2) are not operating.

The fuel cell system, having a low power consumption and thus an advantageously simple design, allows the battery to be provided with additional charge in a controlled manner. This additional charge, which is independent of the devices for providing the power required for charging the battery, offers decisive advantages regarding the service life of the battery, compensation of discharge by leakage currents or stand-by currents or by the maintenance of a minimum state of charge. The additional advantages and applications of the method are similar to the above-described advantages and applications of the system.

A particularly advantageous use of the system according to the present invention and/or the method according to the present invention is in providing additional charge to batteries in land or water vehicles, preferably in motor vehicles.

In particular in vehicles, e.g., in passenger cars, trucks, buses, utility vehicles, rail vehicles, construction vehicles, but also yachts, aircraft, or the like, the intermittent mode of operation of the device for providing the power required for charging the battery, here mostly by the drive motor and a generator, occurs very often. Due to the strict requirements for the battery regarding starting ability of the vehicle or the like after standstill phases, as well as the large number of such vehicles having batteries in circulation, the above-named advantages may be utilized in a particularly favorable manner.

### BRIEF DESCRIPTION OF THE DRAWINGS

Additional advantageous embodiments of the present invention may be derived from the exemplary embodiment elucidated with reference to the drawing, in which:

FIG. 1 shows a schematic diagram of a system including a battery, having a system according to the present invention; and

FIG. 2 shows a schematic diagram of an alternative design of a fuel cell of the system according to the present invention.

### DETAILED DESCRIPTION

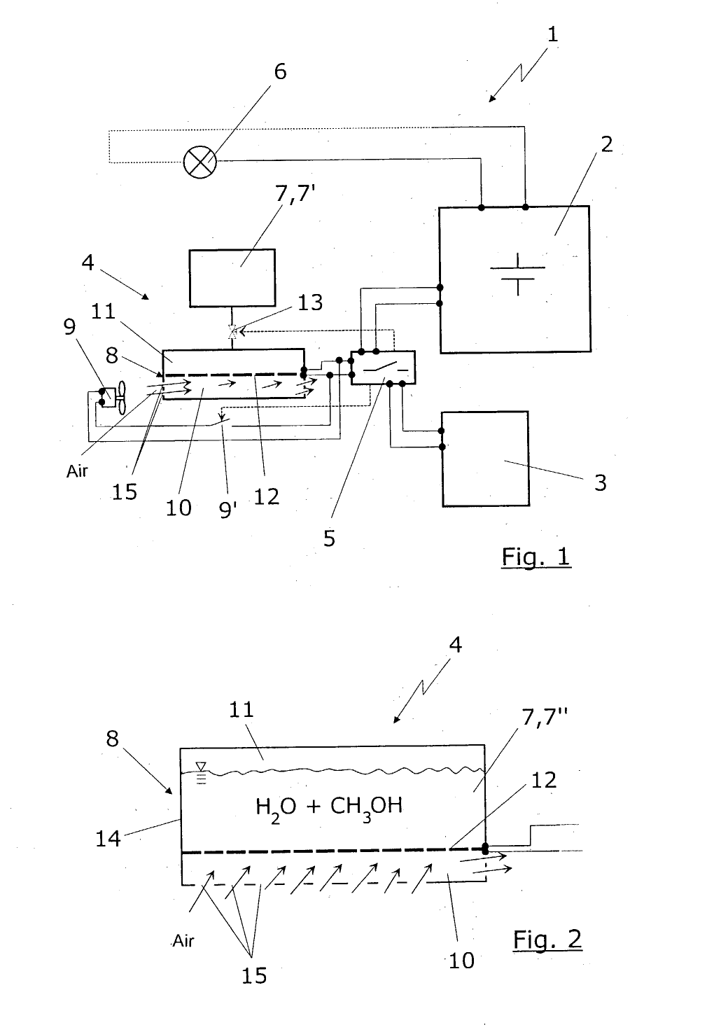

FIG. 1 shows a system 1 for charging a battery 2. System 1 has devices 3 for providing the power required for charging and a fuel cell system 4 as an additional device for supplying power for providing battery 2 with additional charge. Individual components 3, 4, for providing power are connected to battery 2 via a charge regulator, an electronic charge system, or the like, hereinafter referred to as charger 5. Battery 2 is also connected to at least one electric consumer 6, here indicated symbolically.

Battery 2 may be a starter battery, a vehicle system battery or a traction battery of a motor vehicle, while devices 3 may be designed as an electric generator, which draws power from an internal combustion engine and/or by recovery of braking power of the vehicle. In addition, comparable systems for the application of the present invention are also conceivable on boats or yachts, such as power line-independent power supply systems such as for emergency telephones, measuring devices, isolated power supplies, and the like. Devices 3 may be generators driven by internal combustion engines, photovoltaic modules, wind power converters, etc.

Fuel cell system 4 is designed as a basic system having an output of 20-500 W, preferably less than 200 W. It has for this embodiment the necessary components of a fuel tank or supply 7 and a fuel cell 8, as well as an optional blower 9, which, even when present, is generally operated only occasionally. This ensures a design which may be kept at a minimum regarding costs, space, control, and maintenance. For the functions of fuel cell system 4 mentioned previously in the description of providing additional charge to battery 2, the above-described power output of less than 500 W, preferably less than 200 W, is perfectly sufficient. Battery 2, which usually has a capacity of at least 10 Ah, but usually much higher, is actually charged with the energy to be used by battery 2 via devices 3. Fuel cell system 4 only delivers the power required for the additional charge.

Fuel cell 8 itself may be designed as a self-breathing fuel cell 8, which is supplied with the necessary oxygen into the area of its cathode 10, at least for the low and medium power outputs occurring over most of the operating time, by free convection of air. Only for higher outputs is convection via blower 9 utilized if necessary. The power required for operating the blower is then provided by fuel cell 8. Blower 9 is switched on and off via a switch 9′, for example, which is controlled by the charger.

A dedicated air supply for fuel cell 8 via appropriate delivery devices, which might be equipped with air filters, etc., would also, of course, be conceivable.

Supply with fuel also takes place without need for a delivery device or the like, which would in turn require auxiliary power. Depending on the type of fuel cell 8 used, different designs may be used for implementing fuel tank 7.

If a PEM fuel cell is used as fuel cell 8, for example, which is operated using hydrogen gas, fuel tank 7 may be ideally designed as a pressurized cartridge 7′. The hydrogen stored there under pressure may then flow to a membrane 12 of fuel cell 8, driven by the pressure differential between cartridge 7′ and the area of an anode 11. In fuel cell 8, this hydrogen may then be made to react, in an essentially known manner, with the oxygen in air in the area of cathode 10, situated on the other side of the membrane. Depending on the pressure level which is needed in the individual components, a throttling device, for example, in the form of a cross-section restriction in the connecting duct, may be provided in the connection between cartridge 7′ and fuel cell 8.

In order to alleviate the known problems associated with sealing the system when hydrogen is used, an optional valve 13, situated between cartridge 7′ and fuel cell 8, may also be provided. If no power is supplied by fuel cell 8 for providing additional charge to battery 2, valve 13 may be closed. Hydrogen then remains in the area of cartridge 7′, which is much easier to seal than a correspondingly larger system having ducts, fuel cell 8, membrane 12, and the like. In addition, valve 13 may also be used for controlling the supply of fuel, for example, via a valve 13 designed as a solenoid, which may be controlled from charger 5.

Also when a direct methanol fuel cell (DMFC) is used as fuel cell 8, cartridge 7′ and a fuel contained therein under pressure, which in this case is liquid fuel, may be employed. The water/methanol mixture (H₂O+CH₃OH), which is normally used as the fuel in DMFCs, then flows from cartridge 7′ into the area of anode 11. The above-mentioned measures and possible applications are similar to the use of cartridge 7′ with hydrogen. The use of an optional valve 13 is conceivable also in this case.

The use of cartridge 7′ is very advantageous, because it is easily replaceable, for example, when servicing or when refilling with fuel for devices 3 for providing the power required for charging, thus, in the case of motor vehicles, for example, for the drive motor. Fuel may thus be supplied to fuel cell 8 very easily and effectively.

When using a DMFC as a fuel cell, it would also be conceivable, because of the liquid fuel, to store the fuel in an unpressurized fuel tank 7. If fuel tank 7 is situated above anode 11 of fuel cell 8 in the direction of gravity, the force of gravity may be used for supplying fuel cell 8 with fuel, so that the liquid fuel flows into the area of anode 11 by itself, possibly again controlled by valve 13.

When fuel cell 8 is designed as a DMFC, it may also be configured so that one side of membrane 12 is always wetted by liquid fuel, while air may always flow on the other side. This variant is illustrated in FIG. 2. Fuel cell 8 is mounted in a housing 14, which is designed as the housing of an off-the-shelf lead battery, for example. Mounting in a regular support next to battery 2, which is designed as a lead battery, for example, is then very easily possible. Membrane 12 is then situated in housing 14 so that an area 7″ which contains the fuel and practically represents fuel tank 7 integrated into fuel cell 8, is situated above membrane 12 in the direction of gravity. Full wetting of membrane 12 with fuel is thus ensured. On the other side of membrane 12, in the area of cathode 10, the flow of air as oxidant to membrane 12 is ensured by slits 15 in housing 14. Also in this case, the use of blower 9 for improving the air flow, in particular at high required power outputs for supplying battery 2 with additional charge, is again in principle conceivable.

In all of the above embodiments, control or regulation of fuel cell system 4 designed as a basic system is simple conceptually, because the media at membrane 12 are only made to react when electric power from fuel cell 8 is needed for providing battery 2 with additional charge, for example, via charger 5, which may also be designed as an electronic system integrated into battery 2.

What is claimed is:

1. A battery system comprising:
a battery;
at least one intermittently operated device connected to the battery for providing power required for charging the battery; and
an additional fuel cell system connected to the battery for providing power for an additional charge to the battery.

2. The system as recited in claim 1 wherein the fuel cell system has an electric power output of less than 500 W.

3. The system as recited in claim 3 wherein the electric power output is less than 200 W.

4. The system as recited in claim 1 wherein the fuel cell system includes a fuel tank and at least one fuel cell, the fuel cell being self-breathing below a predetermined power output, the fuel tank being designed such that fuel reaches an area of an anode of the fuel cell without aid from a delivery device.

5. The system as recited in claim 4 wherein the fuel tank is a cartridge containing pressurized fuel.

6. The system as recited in claim 4 wherein the at least one fuel cell is a PEM fuel cell operated using hydrogen.

7. The system as recited in claim 4 wherein the at least one fuel cell is a methanol fuel cell.

8. The system as recited in claim 7 wherein the fuel tank is situated above the anode so that gravity delivers the fuel to the area of the anode.

9. The system as recited in claim 1 wherein the fuel cell system includes a blower for assisting air supply when the fuel cell system operates above a predetermined electric power.

10. The system as recited in claim 1 wherein the battery has a capacity of more than 10 Ah.

11. A method of providing a battery, connected to an intermittently operated device for providing power required for charging the battery, with additional charge, the method comprising:
using a fuel cell system to providing the battery with an additional charge when devices for providing the power required for charging the battery are not operating.

12. The method as recited in claim 11 wherein the battery is provided with the additional charge so that stand-by currents, leakage currents and self-discharge are compensated to maintain a specified minimum state of charge.

13. The method as recited in claim 11 wherein the battery is provided with the additional charge as a maintenance charge.

14. The method as recited in claim 11 further comprising using the intermittently operated device to charge the battery.

15. The method as recited in claim 11 further comprising providing the battery in a vehicle, the vehicle being one of a land vehicle, watercraft, or aircraft.

16. The method as recited in claim 11 wherein the vehicle is an engine- or motor-driven vehicle.

17. The method as recited in claim 15 wherein the additional charge is a maintenance charge.

18. A vehicle battery system for a land vehicle, watercraft or aircraft comprising:
a battery;
at least one intermittently operated device connected to the battery for providing power required for charging the battery; and
an additional fuel cell system connected to the battery for providing power for an additional charge to the battery
